(19) United States
(12) Patent Application Publication
(10) Pub. No.: US 2005/0050778 A1
(43) Pub. Date: Mar. 10, 2005

(54) Rotational information display device

(76) Inventors: Seongukk Kim, Seoul (KR); Hyewon Baek, Seoul (KR); Sean Lee, Huntington, NY (US)

Correspondence Address: WELLS ST. JOHN P.S., 601 W. FIRST AVENUE, SUITE 1300, SPOKANE, WA, 99201, US

(21) Appl. No.: 10/660,408

(22) Filed: Sep. 10, 2003

(51) Int. Cl. G09F 13/00

(52) U.S. Cl. 40/431

(57) ABSTRACT

The present invention provides a structure of a rotation frame of a rotational information display device which is capable of displaying a 3D image based on an afterimage effect by rotating a light source like a light emitting diode (LED). The rotation frame includes an outer most display unit, an inner most display unit and an intermediate display unit. The outer most display unit is longitudinally formed in an outer most portion from the rotary shaft in a longitudinal direction of the rotary shaft for thereby displaying a certain image in an outer circumferential surface of the image space formed as the light sources are rotated. The inner most display unit is longitudinally formed from the rotary shaft in a longitudinal direction of the rotary shaft for thereby displaying a certain image in a center portion of the image space. A plurality of intermediate display units are formed in parallel with respect to the outer most and inner most display units between the outer most display unit and the inner most display unit, and each of the same is distanced from each other in a radius direction, so that it is possible to display a certain image between the outer surface and the center portion of the image space as the light sources are rotated.

### BACKGROUND OF THE INVENTION

1. Field of the Invention

The present invention relates to a rotational information display device, and in particular to a rotational information display device by which it is possible to display various information such as a character, numeral, 3D figure, image, etc. in a space. The rotational information display device may be installed in an indoor or outdoor and may be used as an advertising means for providing a customer with a certain commercial expression, image or other information.

2. Description of the Background Art

A rotational information display device is implemented using an afterimage effect which is a kind of an optical illusion phenomenon. In the above device, a plurality of light sources installed in a certain rotational frame are rotated, and each light source is on and off in accordance with a programmed time, so that a person recognizes a certain image or character based on an on and off operation of the light sources.

Referring to FIG. 1, a conventional rotational information display device comprises a rotational frame 10, and a housing 1 which has a motor 2 adapted to rotate the rotation frame.

The motor 2 is installed in a lower portion of the housing 1 and is driven by a power supplied from a power supply apparatus 4. A rotary shaft 3 is engaged to an upper portion of the motor 2 and is rotated based on an operation of the motor. A controller 6 is installed in an upper portion of the rotary shaft 3 and is operated based on a power from the power supply apparatus 4. Here, the power supply from the power supply apparatus is performed through a connector 5 which electrically connects the rotary shaft and the power supply apparatus. In addition, a balance support 7 is installed in an upper portion of a control panel for fixing a rotational frame 10. The rotation frame fixed to the balance support is rotated when the motor is rotated.

A fixture 11 which is a lower portion of the rotation frame 10 is detachably fixed to the balance support 7. An arch shaped first light emitting diode support 13 is formed in one side of the upper portion of the fixture 11. A linear frame rotational wing 12 is longitudinally formed in a portion opposite to the first light emitting diode support. A second light emitting diode support 14 having a relatively shorter length is vertically formed in an end of the frame rotational wing. A plurality of light emitting diodes 15 are installed in the light emitting diode supports 13 and 14. A wiring line (not shown) is provide in the interior or an outer surface of the light emitting diode supports for supplying a power to the light emitting diodes 15.

As the conventional rotation frame 10 is rotated by the rotating motor 2, the light emitting diodes 15 installed in the rotation frame are on and off, so that a 3D information or image is displayed in the space. Here, the controller 6 controls the on and off time and positions of the light emitting diodes 15 in accordance with a previously programmed algorithm for thereby implementing a display of a 3D image.

The samples of the images formed based on the rotation of the conventional rotation frame are shown in FIG. 2. As shown therein, as the rotation frame 10 is rotated, the light emitting diodes installed in the first light emitting diode support 13 form a certain spherical trace, and the light emitting diodes installed in the second light emitting diode support 14 form a wide cylindrical trace. At this time, since a certain character may be displayed on the surface of each of the above traces, the surface is called as an image plane.

In the case that when the rotation frame is rotated at a certain revolution, it is possible to display a certain character on the image plane by controlling the on and off operations of the light emitting diodes. For example, the character “A” is shown in the left side of FIG. 2.

However, in the conventional rotation frame, it is impossible to implement various images like the shape of a certain item except for the character using the conventional rotation frame.

In addition, there is a certain limit for implementing an actual 3D image display apparatus capable of displaying a certain image. In the conventional rotation frame structure, it is impossible to implement an asymmetrical image except for a left and right symmetrical image.

In order to implement a 3D image, an image displaying technique is developed using a hologram or a laser. However, the product is expensive, and a control is impossible for an image display.

### SUMMARY OF THE INVENTION

Accordingly, it is an object of the present invention to provide an improved rotational information display device which overcomes the problems encountered in the conventional art.

It is another object of the present invention to provide a rotational information display device by which it is possible to display various images (in particular, 3D image) like the shapes of items in a space by providing a rotation frame having an improved structure compared to a conventional rotation frame, and an asymmetrical image is displayed in a space.

To achieve the above objects, in a rotational information display device which includes a housing, a motor installed in the housing and driven when a power is supplied, a wire line for supplying power, and a rotation frame which is engaged to a rotary shaft of the motor and is rotated, there is provided a rotational information display device, comprising the rotation frame which includes an outer most display unit which is longitudinally formed in an outer most portion from the rotary shaft in a longitudinal direction of the rotary shaft and is adapted to display a certain image on an outer circumferential surface of an image space formed as the light sources engaged thereon are rotated; an inner most display unit which is longitudinally formed from the rotary shaft in a longitudinal direction of the rotary shaft and is adapted to display a certain image on a center portion of the image space as the light sources engaged thereon are rotated; a plurality of intermediate display units which are installed parallel with respect to the display units between the outer most display unit and the inner most display unit, each of the same being distanced from each other in a radius direction of the rotary shaft, and a certain image is displayed between the outer circumferential surface of the image space and the center as the light sources engaged thereon are rotated; and a plurality of display unit supports which are adapted to integrally connect the display units and to fix the same to the rotary shaft, wherein it is possible to display a 3D image in an image space by controlling an on and off of the light sources as the rotation frame is rotated.

In addition, the intermediate display units are distanced from the outer most display unit at a certain angle with respect to the rotary shaft in such a manner that the light sources each having a smaller rotational radius are not covered by the light sources each having a larger rotational radius.

Each display unit is symmetrically installed with respect to the rotary shaft for thereby minimizing the vibration of the rotary frame.

The rotational information display device includes an image storing device for storing a 3D image information converted into a cylindrical coordinater (r, θ, z: radius, angle, height); a sensor for measuring a rotational angle of the rotation frame; and a central processing unit adapted to supply a power to a light source which is most matched with a height “z” among the 3D image information based on a rotational angle θ among the light sources of the display unit of the radius nearest the radius “r” in the 3D image information.

### BRIEF DESCRIPTION OF THE DRAWINGS

The present invention will become better understood with reference to the accompanying drawings which are given only by way of illustration and thus are not limitative of the present invention, wherein;

FIG. 1 is a cross sectional view illustrating a conventional rotational information display device;

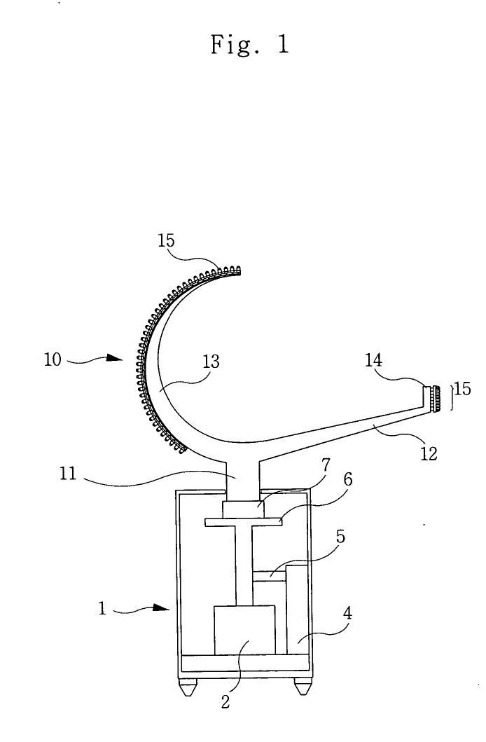

FIG. 2 is a view illustrating an image formed based on the rotation of a rotation frame of a conventional rotational information display device;

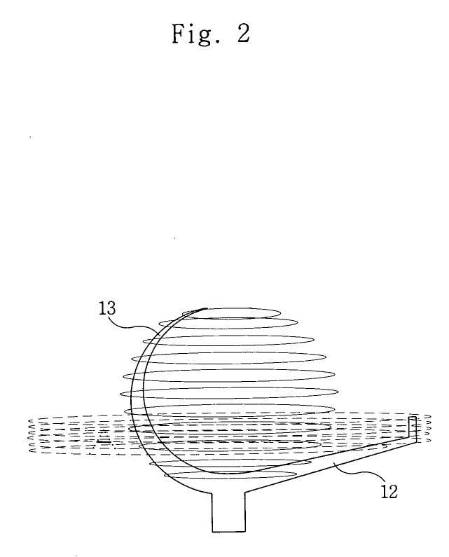

FIG. 3 is a view illustrating a rotational information display device having a rotation frame according to a first embodiment of the present invention;

FIG. 4 is a view illustrating a state that the positions of dots in an image space are expressed by coordinate values x, y and z of an orthogonal coordinate;

FIG. 5 is a view illustrating a rotation frame according to a second embodiment of the present invention;

FIG. 6 is a view illustrating an operation state of a rotational information display device of FIG. 4;

FIG. 7 is a view illustrating a rotation frame according to a third embodiment of the present invention;

FIG. 8 is a view illustrating a rotation frame according to a fourth embodiment of the present invention, and

FIG. 9 is a view illustrating a rotation frame according to a fifth embodiment of the present invention.

### DETAILED DESCRIPTION OF THE PREFERRED EMBODIMENTS

The preferred embodiments of the present invention will be described with reference to the accompanying drawings.

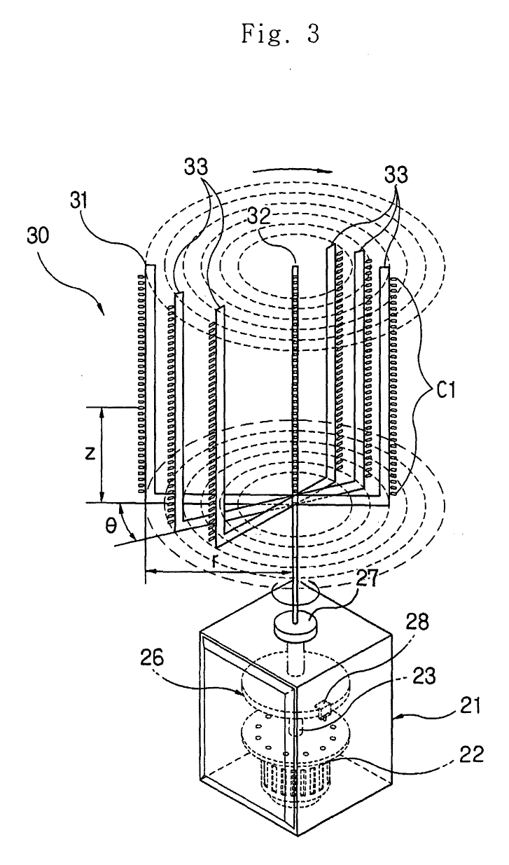

FIG. 3 is a view illustrating a rotational information display device having a rotation frame according to a first embodiment of the present invention. Referring to FIG. 3, the rotational information display device includes a housing 21 and a rotation frame 30.

In the housing, there are provided a motor 22 driven by an internal or external type power supply apparatus (not shown), a rotary shaft 23 rotated based on the rotation of the motor, a light source controller 26, and a balance support 27 adapted to support the rotation frame.

The rotation frame 30 comprises an outer most display unit 31 which has a light source C1 for displaying an image based on the rotation of the rotation frame, an inner most display unit 32, a plurality of intermediate display units 33, and a plurality of display unit supports 34 adapted to connect the display units and to integrally fix the same.

The outer most display unit 32 is extended from the rotary shaft longitudinally in the direction of the rotary shaft 23 of the motor, namely, in the vertical direction in the drawings. The light sources C1 are intensively provided in the outer most display unit 32. In addition, the outer most display unit 31 and the intermediate display unit 33 are longitudinally extended in the direction of the rotary shaft. The light sources C1 are intensively provided in the outer most display unit 31 and the intermediate display unit 33, respectively.

In addition, a plurality of display unit supports 34 adapted to integrally connect and fix the display units 31, 32 and 33 each have a bar for connecting the lower portions of each display unit.

The outer most display unit 31 is named for the reason that the light source C1 is provided in a portion most distanced from the rotary shaft. The display unit supports adapted to support the outer most display unit 31 are longest compared to the other supports. The lengths of the supports of the intermediate display units 33 are gradually decreased in the counterclockwise direction from the outer most display unit 31. At this time, the distance from the rotary shaft 23 of each display unit is indicated by “r”.

The intermediate display units 33 are installed and distanced from each other at a certain angle based on the rotation direction of the rotation frame with respect to the outer most display unit 31. At this time, the spaced apart distances of each display unit are represented by θ based on the outer most display unit.

Therefore, with the above descried construction, it is possible to display various 3D images in the interior of a cylindrical trace which is formed as the outer most display unit 31 is rotated. A plurality of image planes which are formed as each display unit 31, 32, 33 is rotated, form one image space capable of displaying a 3D image therein. The surface of the image plane formed as the outer most display unit 31 is rotated and the space formed therein are hereinafter called as an image space.

It is possible to display a certain image in the outer surface of the image space and the interior of the same using a certain number of light sources in such a manner that the spaced apart distances of the intermediate display units in a radial direction are decreased. In addition, it is possible to increase a resolution of a 3D image by increasing the number of light sources attached to the display units.

The display units are distanced from each other with respect to the rotary shaft at a certain angle, so that the light sources attached on the display units having a smaller radius are not covered by the display units having a relatively larger radius. It is possible to minimize the vibration of the rotation frame due to an inclination of the weight during the rotation in such a manner that each display unit is positioned symmetrically with respect to the rotary shaft.

In the embodiment of the present invention, the light emitting diodes are used as the light source. Here, the light emitting diodes may have single color or various different colors. Preferably, as the light sources, an incandescent electric lamp, an electric vacuum or gas discharge lamp may be adapted instead of the light emitting diodes.

The procedures that the 3D image is generated using the rotation frame 30 will be described.

A certain 3D image is implemented using a 3D image generation program like the conventional manner. The implemented 3D modeling is formed of a many number of dots. Each dot has a certain coordinate value of x, y, and z which each represent a certain position with respect to an orthogonal coordinate. A position information of the orthogonal coordinate arte converted into a position information of a cylindrical coordinate (r, θ, z: radius, angle, height) based on a known conversion method.

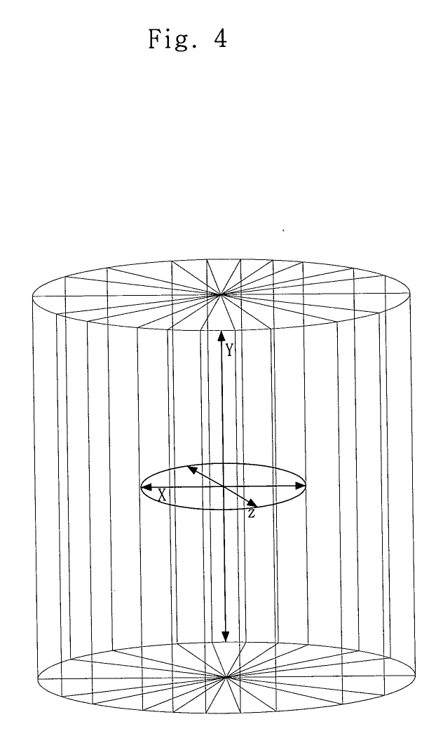

FIG. 4 is a view illustrating a procedure that the position of a certain dot of an image space is shown based on a coordinate value x, y and z of an orthogonal coordinate. A certain dot (not shown) of the image space represents a position of a light emitting diode engaged in each display unit 31, 32, 33 or a position that the light emitting diode is on and off when the light emitting diode is rotated.

When the rotation frame is rotated as the power is supplied to the motor provided in the rotational information display device, the rotational angle is measured with respect to one display unit of the rotational frame 30. Assuming that the outer most display unit 31 is referred to the rotational angle measuring reference, the sensor measures the rotational angle 0 of the outer most display unit 31. An encoder which is capable of measuring the rotation of the light source controller 26 and is rotated in the same manner as the rotation frame may be used for the sensor 28.

Here, since the radius “r” of the outer most display unit 31 is previously determined, when the power is supplied to the light sources having a certain height “z” corresponding to the radius of the rotational angle, a desired lineal shape is formed in the outer most display unit 31. Therefore, it is possible to display a desired shape on the outer surface of the rotational space by repeatedly performing the above procedures during the rotation of the outer most display unit 31.

In the case of the intermediate display units 33, since the radius of each intermediate display unit 33 and the angle between the intermediate display unit and the reference outer most display unit 31 are previously determined, the rotational angle of each intermediate display unit may be obtained by adding the measured angle of the outer most display unit with the angle between each intermediate display unit and the outer most display unit.

Therefore, each intermediate display unit is capable of displaying a certain image on the circumferential surface of the rotational space having a certain radius as the power is supplied to the light emitting diode C1 attached on the display units in accordance with an image stored in the light emitting diodes C1 in the same manner that the outer most display unit 31 displays a 3D image on the circumferential surface of the rotational space.

Therefore, as each display unit is rotated, a certain image is displayed on the circumferential surface of each rotational space based on the stored image, so that it is possible to reproduce a desired 3D image.

When a 3D image transformed at one revolution or a certain number of revolutions is outputted to each light source, it is possible to display a 3D animated image.

The structure of the rotation frame capable of displaying various images in a space will be described according to another embodiment of the present invention.

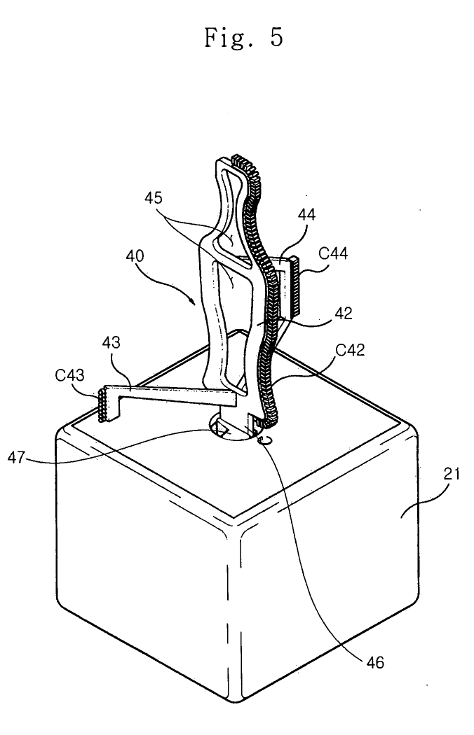

FIG. 5 is a view illustrating a rotational information display device having a rotation frame according to a second embodiment of the present invention. As shown therein, the rotational information display device comprises a rotation frame 40, and a housing 21 which accommodates a motor therein for rotating the rotation frame. The construction of the another embodiment of the present invention is same as the construction of the earlier embodiment of the present invention except for the rotational frame 40.

In the present invention, the rotation frame 40 is engaged to the upper portion of the housing 21 and is rotated. The light sources C42, C43 and C44 are on and off based on the rotation of the rotation frame 40, so that a beverage bottle is displayed in 3D. At this time, a fixture 46 is provided in the lower portion of the rotation frame 40 for being engaged to the upper portion of the housing. A plurality of hollow holes 25 are formed in the center portion of the rotation frame for implementing a weight decrease of the rotation frame and a smooth rotation of the same.

A first light emitting diode support 26 formed in a shape of a beverage bottle is formed in the upper portion of the fixture 46. The light sources C42 formed of light emitting diodes are intensively provided along an outer surface of one side of the first light emitting diode support. Therefore, the light source C42 displays a shape of a beverage bottle based on the rotation of the rotation frame.

In addition, the light sources C43 are provided in an end of the second light emitting support 43 longitudinally protruded in the vertical direction with respect to the first light emitting support 26, and the light sources C44 are provided in one side of the third light emitting diode support protruded in the direction opposite to the direction that the second light emitting support is protruded.

At this time, the length of the second light emitting support is longer than the length in the radius direction of the third light emitting support, and the position in the vertical direction of the light sources C44 engaged in the third light emitting diode support is higher than the position in the vertical direction of the light sources C43 engaged to the second light emitting diode support.

A wire line (not shown) is installed in the interior or the outer surfaces of the light emitting diode supports for supplying the power to the light sources C42, C43 and C44.

The operation state of the rotational information display device having a rotation frame according to the present invention will be described.

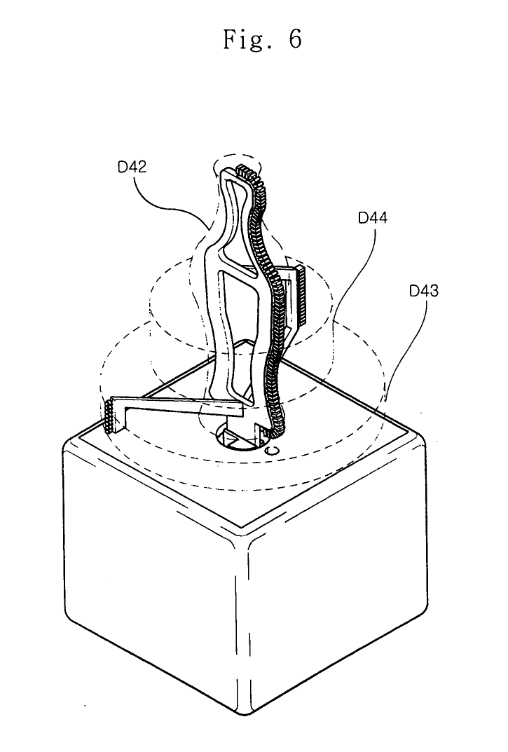

FIG. 6 is a view illustrating an operation state of the rotational information display device of FIG. 5.

As shown therein, the rotation frame 40 fixed to the balance support 47 is rotated as the motor accommodated in the housing 21 is driven. The light sources C42, C43 and C44 engaged in the rotation frame form a certain rotational trace D42, D43, D44.

At this time, the trace D42 forms a shape of a beverage bottle in 3D, and various characters may be displayed on the traces D43 and D44 based on an on and off of the light sources controlled by the controller.

Here, it is needed to constantly maintain a revolution of the rotational frame in order to implement a character display based on an afterimage effect. Preferably, the revolution is about 1300˜1500 rpm.

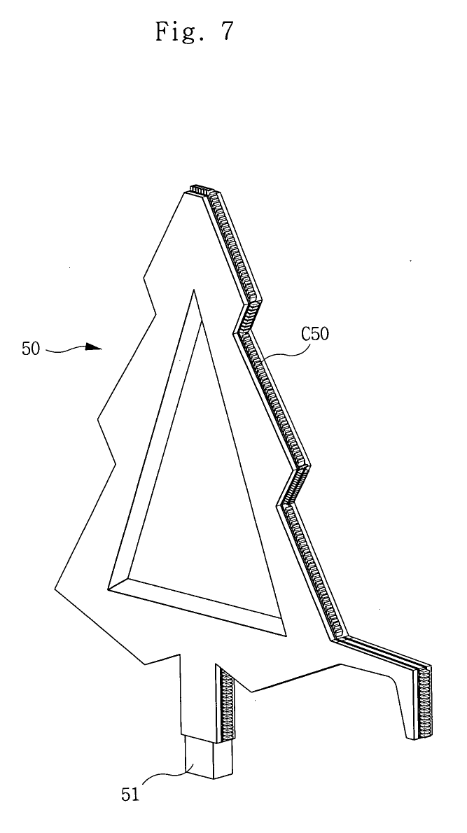

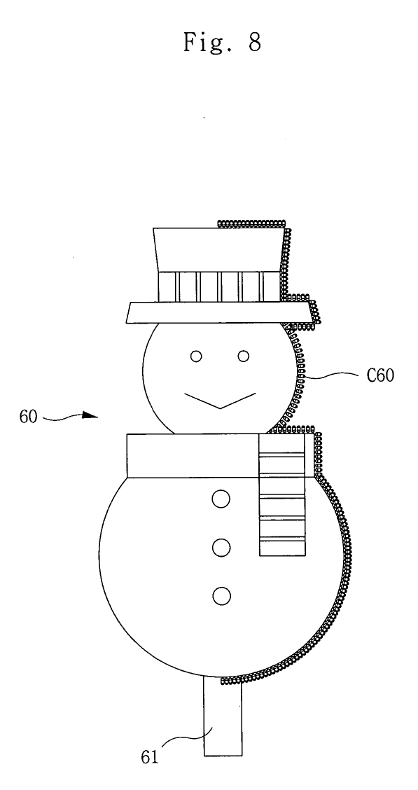

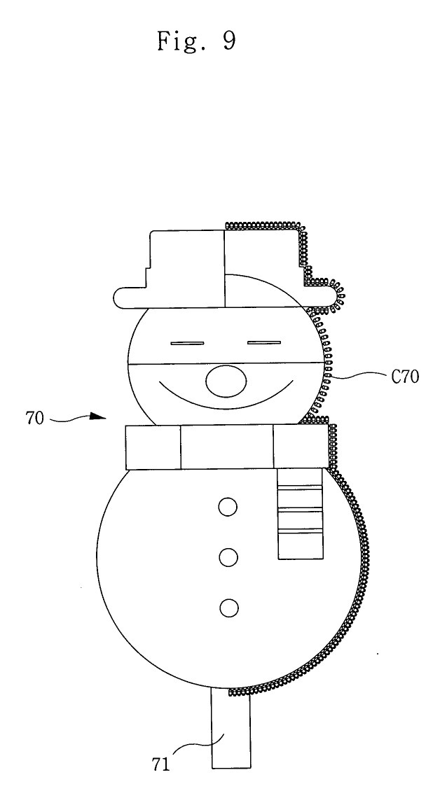

FIGS. 7, 8 and 9 are views illustrating a rotation frame according to the third, fourth and fifth embodiments of the present invention. FIG. 7 shows a Christmas tree, and FIGS. 8 and 9 show a rotation frame capable of displaying a snowman.

As shown therein, the fixtures 51, 61, and 71 are provided in the lower portions of the rotation frames 50, 60 and 70. The light sources C50, C60 and C70 are provided in one side surface of each rotation frame for thereby corresponding to the outer shapes of a certain item. Therefore, the shapes of each item are displayed in a space in 3D based on the arrangements of each light source as the rotation frame is rotated.

The 3D constructions according to the third, fourth and fifth embodiment of the present invention may be implemented based on the rotation frames according to the first embodiment of the present invention. The first light emitting diode support according to the second embodiment of the present invention may be adapted.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a rotational information display device which includes a housing, a motor installed in the housing and driven when a power is supplied, a wire line for supplying power, and a rotation frame which is engaged to a rotary shaft of the motor and is rotated, a rotational information display device, comprising:
said rotation frame which includes:
an outer most display unit which is longitudinally formed in an outer most portion from the rotary shaft in a longitudinal direction of the rotary shaft and is adapted to display a certain image on an outer circumferential surface of an image space formed as the light sources engaged thereon are rotated;
an inner most display unit which is longitudinally formed from the rotary shaft in a longitudinal direction of the rotary shaft and is adapted to display a certain image on a center portion of the image space as the light sources engaged thereon are rotated;
a plurality of intermediate display units which are installed parallel with respect to the display units between the outer most display unit and the inner most display unit, each of the same being distanced from each other in a radius direction of the rotary shaft, and a certain image is displayed between the outer circumferential surface of the image space and the center as the light sources engaged thereon are rotated; and
a plurality of display unit supports which are adapted to integrally connect the display units and to fix the same to the rotary shaft,
wherein it is possible to display a 3D image in an image space by controlling an on and off of the light sources as the rotation frame is rotated.

2. The device of claim 1, wherein said intermediate display units are distanced from the outer most display unit at a certain angle with respect to the rotary shaft in such a manner that the light sources each having a smaller rotational radius are not covered by the light sources each having a larger rotational radius.

3. The device of claim 1, wherein each display unit is symmetrically installed with respect to the rotary shaft for thereby minimizing the vibration of the rotary frame.

4. The device of either claim 1 or claim 3, wherein said rotational information display device includes:
an image storing device for storing a 3D image information converted into a cylindrical coordinate (r, θ, z: radius, angle, height);
a sensor means for measuring a rotational angle of the rotation frame; and
a central processing unit adapted to supply a power to a light source which is most matched with a height “z” among the 3D image information based on a rotational angle θ among the light sources of the display unit of the radius nearest the radius “r” in the 3D image information.

5. The device of either claim 1 or claim 4, wherein a 3D image formed by the rotation of the rotation frame is asymmetrical in left and right directions.

6. In a rotational information display device which includes a housing, a motor installed in the housing and driven when a power is supplied, a wire line for supplying power, and a rotation frame which is engaged to a rotary shaft of the motor and is rotated, a rotational information display device, comprising:
said rotation frame which includes:
a first light emitting diode support in which the light sources are arranged based on an outer shape of an item for thereby displaying the shape of the item in 3D based on the rotation of the rotation frame;
a second light emitting diode support which is longitudinally protruded in a vertical direction with respect to the first light emitting diode support and has a front end in which the light sources are engaged; and
a third light emitting diode support which is protruded in a direction opposite to the direction that the second light emitting diode support is protruded and has a plurality of light sources engaged in one side of the same.

7. The device of claim 6, wherein an arrangement of the light sources engaged in the first light emitting support corresponds to an outer shape of a beverage bottle.

8. The device of claim 6, wherein an arrangement of the light sources engaged in the first light emitting diode support corresponds to an outer shape of a Christmas tree.

9. The device of claim 6, wherein an arrangement of the light sources engaged in the first light emitting diode support corresponds to an outer shape of a snowman with a hat.
